(19) United States
(12) Patent Application Publication
(10) Pub. No.: US 2023/0135122 A1
(43) Pub. Date: May 4, 2023

(54) Plumber Rotor Machine Helper Device

(71) Applicant: Roberto Coronel, Union City, CA (US)

(72) Inventor: Roberto Coronel, Union City, CA (US)

(21) Appl. No.: 18/050,677

(22) Filed: Oct. 28, 2022

Related U.S. Application Data
(60) Provisional application No. 63/273,240, filed on Oct. 29, 2021.

(51) Int. Cl. E03C 1/302; F16L 7/00

(52) U.S. Cl. CPC E03C 1/302; F16L 7/00

(57) ABSTRACT

The present invention relates to a novel plumbing drain cable device. The drain cable device is a device for cleaning a plumbing drain blockage. The device is comprised of a flexible stainless steel corrugated tube with a nut on one end to allow connections for multiple extensions to lengthen the tube, as needed. The device has a rubber coating on the outside to help assist with grip and is cut at a 45-degree angle with rubber coating wrapped around the inside edge of the cutout to protect a user from cuts. Users would bend the tube in the direction of a drain fitting. A snake machine cable will travel through the tube of the device and up the direction of the drain to the clogged area. Thus, the device helps guide rotor machine cables through a one way clean out without getting the cable kinked and/or stuck.

### CROSS-REFERENCE TO RELATED APPLICATION

The present application claims priority to, and the benefit of, U.S. Provisional Application No. 63/273,240, which was filed on Oct. 29, 2021, and is incorporated herein by reference in its entirety.

### FIELD OF THE INVENTION

The present invention relates generally to the field of plumbing drain cable devices. More specifically, the present invention relates to an improved plumbing drain cable device that provides users with a device for clearing plumbing drain blockages and is designed to remove the blockage without damaging a rotor machine. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in plumbing drain cable devices. Cleaning blockages in plumbing systems can take a considerable amount of time and money. Further, a plumber's rotor machine cable can get damaged trying to clear blockages. Plumbing companies may have to frequently replace their rotor machine cable due to kinks.

Additionally, the rotating motion of a plumber's drain cleaning cable can cause damage to adjacent items in the work area. Further, the plumber's drain cleaning cable can cause messes and spread dirt and debris during use. Accordingly, there is a need for a cleaning cable device that protects the plumbing cable device by being positioned over a particular section of a plumber's drain cleaning cable as needed on the worksite. Further, there is a need for a plumber to be able to have the option of joining multiple drain cable devices together as needed. Further, there is a need for a drain cleaning cable that will fit various sizes of plumber's drain cleaning cables.

Therefore, there exists a long-felt need in the art for a plumbing drain cable device that provides users with a device for cleaning plumbing drain blockages designed to remove the blockage without damaging a rotor machine. There is also a long-felt need in the art for a plumbing drain cable device that utilizes a stainless-steel corrugated tube to guide the rotor machine cable through tight and sharp turns within the system. Further, there is a long-felt need in the art for a plumbing drain cable device that features a rubber coating on the exterior to assist with grip when inserted into the system. Moreover, there is a long-felt need in the art for a device that allows users to bend the tube within the drain fitting and add extensions via a nut and adapter, if needed. Further, there is a long-felt need in the art for a plumbing drain cable device that ensures a snake machine cable can travel through the tube and up the direction of the drain without causing damage to the rotor machine. Finally, there is a long-felt need in the art for a plumbing drain cable device that provides users with a device that saves time and money without frequently replacing the rotor machine cable due to kinks.

The subject matter disclosed and claimed herein, in one embodiment thereof, comprises a plumbing drain cable device. The drain cable device is a device for cleaning a plumbing drain blockage. The device is comprised of a flexible stainless steel corrugated tube with a nut on one end to allow connections for multiple extensions to lengthen the tube, as needed. The device has a rubber coating on the outside to help assist with grip and is cut at a 45-degree angle with rubber coating wrapped around the inside edge of the cutout to protect a user from cuts. Users would bend the tube in the direction of a drain fitting, and if more extensions are needed, the nut and adapter will allow the user to add more extensions. A snake machine cable will travel through the tube of the device and up the direction of the drain to the clogged area. The stainless-steel corrugated tube will have the stiffness and flexibility to be shaped in any way to help guide rotor machine cables through a one way clean out without getting the cable kinked and/or stuck.

In this manner, the plumbing drain cable device of the present invention accomplishes all of the foregoing objectives and provides users with a device that prevents a rotor machine cable from kinking. The device provides users with a flexible tube for enclosing the rotor machine cable. The device comprises a rubber/poly coating which helps with better grip and easy cleanup.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plumbing drain cable device. The drain cable device is a device for cleaning a plumbing drain blockage. The device is comprised of a flexible stainless steel corrugated tube with a nut on one end to allow connections for multiple extensions to lengthen the tube, as needed. The device has a rubber coating on the outside to help assist with grip and is cut at a 45-degree angle with rubber coating wrapped around the inside edge of the cutout to protect a user from cuts.

In one embodiment, the plumbing drain cable device comprises a flexible hose or tube. The flexible hose or tube can be any suitable shape or size as is known in the art, as long as the flexible tube is sized and shaped to retain a snake machine cable within it. Specifically, the tube of the device encapsulates the snake machine cable. Generally, once the tube of the device is in place, the snake machine cable is threaded through it to clear the drain blockage.

In another embodiment, the flexible hose or tube is manufactured of stainless steel, aluminum, polymers, or other suitable flexible materials as is known in the art. Typically, the flexible hose is made from materials which are durable and provide strength and rigidity as well as resistance to rusting. Further, the flexible hose would be fabricated using known techniques such as extrusion.

In one embodiment, the flexible tube or hose is corrugated, such that the tube can bend in the direction of the drain fitting and retain its shape. The corrugated tube comprises enough flexibility to be bent in various directions, and also comprises enough rigidity that the tube can be directed through the drain. Thus, the corrugated tube guides the encapsulated snake machine cable through a one way clean out without getting the cable kinked and/or stuck.

In one embodiment, the flexible tube comprises a coupling affixed to at least one end. In another embodiment, the flexible tube comprises a coupling affixed to both ends. The coupling comprises at least one of a nut, a spring coupler, a push coupling, etc., or any other suitable coupling as is known in the art. The coupling allows a connection for an extension component. The extension component lengthens the flexible tube. Any suitable number of extensions can be utilized as is known in the art, depending on the needs and/or wants of a user. The couplings on the ends of the flexible tube allow the user to join multiple drain cable devices together as needed.

In one embodiment, the flexible tube comprises a rubber coating on the outside surface for assisting with grip and durability, as well as providing easy cleanup. Further, any other suitable coating could be utilized as is known in the art, such as silicone, polymers, etc.

In another embodiment, an end of a flexible tube is cut at approximately a 45-degree angle, which helps guide the tube down the drain. The angled end helps guide the tube around corners without getting stuck. In one embodiment, the rubber coating is wrapped around the inside edge of the 45-degree angle cutout to protect a user from cuts, scratches, etc., during use.

The plumbing drain cable device is utilized to protect the work area from the actions of a plumber's snake machine cleaning cable. Further, operation of a plumber's snake machine cleaning cable is made safer and easier to use with a drain cable device. Additionally, the plumbing drain cable device is designed to be used with any size plumber's snake machine cleaning cable as is known in the art.

In yet another embodiment, the plumbing drain cable device comprises a plurality of indicia.

In use, users would bend the flexible tube of the plumbing drain cable device in the direction of a drain fitting, and if more extensions are needed, the nut and adapter component will allow the user to add more extensions to the flexible tube, as needed. A snake machine cable will then be threaded into the flexible tube, to travel through the flexible tube of the device and up the direction of the drain to the clogged or blocked area. Thus, the flexible tube of the device will have the stiffness and flexibility to be shaped in any way to help guide the snake machine cables through a one way clean out without getting the cables kinked and/or stuck, and by allowing for easy cleanup.

In yet another embodiment, a method of clearing a plumbing drain blockage is described. The method includes the steps of providing a plumbing drain cable device comprising a flexible stainless steel corrugated tube with a nut on one end to allow connections for multiple extensions to lengthen the tube as needed. The method also comprises bending the tube in the direction of a drain fitting. Further, the method comprises adding more extensions via the nut and adapter, if extensions are needed. The method also comprises inserting a snake machine cable through the tube of the device and up the direction of the drain to the clogged area. Finally, the method comprises guiding the snake machine cable through a one way clean out without getting the cable kinked and/or stuck.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the plumbing drain cable device of the present invention with a snake machine cable being inserted into the device in accordance with the disclosed architecture;

FIG. 2 illustrates a perspective view of one embodiment of the plumbing drain cable device of the present invention in accordance with the disclosed architecture;

FIG. 3 illustrates a perspective view of one embodiment of the plumbing drain cable device of the present invention in use in accordance with the disclosed architecture; and

FIG. 4 illustrates a flowchart showing the method of clearing a plumbing drain blockage in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a plumbing drain cable device that provides users with a device for cleaning plumbing drain blockages designed to remove the blockage without damaging a rotor machine. There is also a long-felt need in the art for a plumbing drain cable device that utilizes a stainless-steel corrugated tube to guide the rotor machine cable through tight and sharp turns within the system. Further, there is a long-felt need in the art for a plumbing drain cable device that features a rubber coating on the exterior to assist with grip when inserted into the system. Moreover, there is a long-felt need in the art for a device that allows users to bend the tube within the drain fitting and add extensions via a nut and adapter, if needed. Further, there is a long-felt need in the art for a plumbing drain cable device that ensures a snake machine cable can travel through the tube and up the direction of the drain without causing damage to the rotor machine. Finally, there is a long-felt need in the art for a plumbing drain cable device that provides users with a device that saves time and money without frequently replacing the rotor machine cable due to kinks.

The present invention, in one exemplary embodiment, is a novel plumbing drain cable device. The drain cable device is a device for cleaning a plumbing drain blockage. The device is comprised of a flexible stainless steel corrugated tube with a nut on one end to allow connections for multiple extensions to lengthen the tube, as needed. The device has a rubber coating on the outside to help assist with grip and is cut at a 45-degree angle with rubber coating wrapped around the inside edge of the cutout to protect a user from cuts. The present invention also includes a novel method of clearing a plumbing drain blockage. The method includes the steps of providing a plumbing drain cable device comprising a flexible stainless steel corrugated tube with a nut on one end to allow connections for multiple extensions to lengthen the tube as needed. The method also comprises bending the tube in the direction of a drain fitting. Further, the method comprises adding more extensions via the nut and adapter, if extensions are needed. The method also comprises inserting a snake machine cable through the tube of the device and up the direction of the drain to the clogged area. Finally, the method comprises guiding the snake machine cable through a one way clean out without getting the cable kinked and/or stuck.

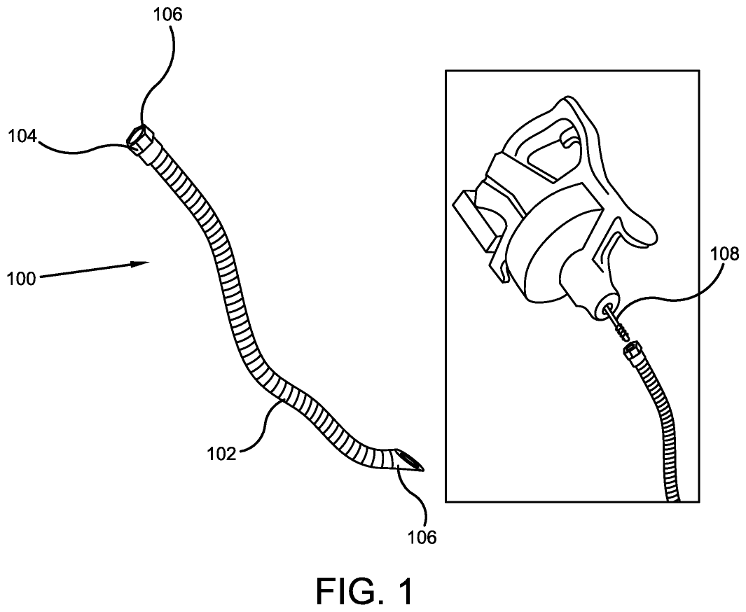

Referring initially to the drawings, FIG. 1 illustrates a perspective view of one embodiment of the plumbing drain cable device 100 of the present invention. In the present embodiment, the plumbing drain cable device 100 is an improved drain cable device 100 that is used for clearing a plumbing drain blockage. The plumbing drain cable device 100 comprises a tube 102 with a nut 104 on one end 106 to allow for connections of multiple extensions.

The plumbing drain cable device 100 comprises a flexible hose or tube 102. The flexible hose or tube 102 can be any suitable shape or size as is known in the art, as long as the flexible tube 102 is sized and shaped to retain a snake machine cable 108 within it. Specifically, the tube 102 of the device 100 encapsulates the snake machine cable 108. Generally, once the tube 102 of the device 100 is in place, the snake machine cable 108 is threaded through it to clear the drain blockage.

Further, the flexible hose or tube 102 is manufactured of stainless steel, aluminum, suitable polymers, or any other suitable flexible materials as is known in the art, depending on the needs and/or wants of a user. Typically, the flexible hose 102 is made from materials which are durable and provide strength and rigidity as well as resistance to rusting. Further, the flexible hose 102 would be fabricated using known techniques such as extrusion, or any other suitable methods as is known in the art. One skilled in the art will understand that any suitable material possessing an appropriate amount of flexibility, rigidity, and resiliency may be used to manufacture the flexible tube 102 of the plumbing drain cable device 100.

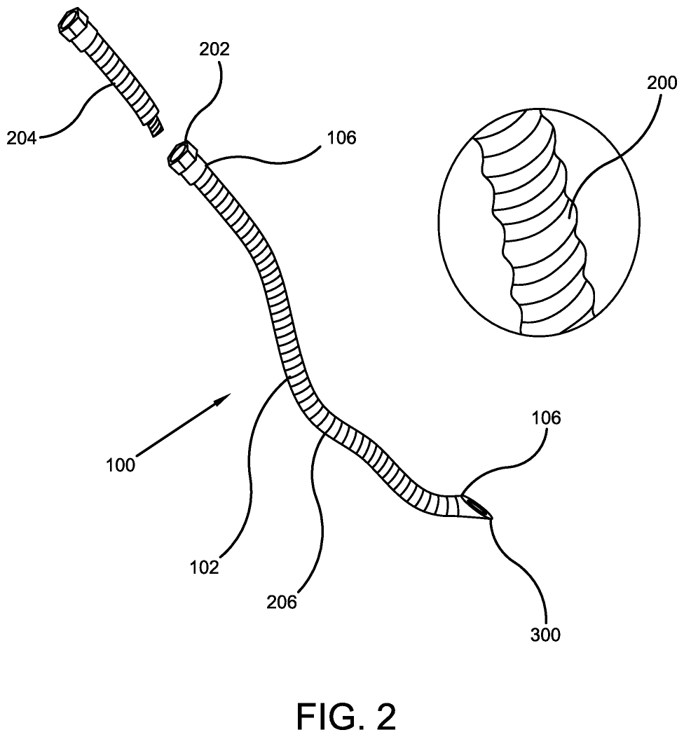

As shown in FIG. 2, the flexible tube or hose 102 is corrugated 200 along its length, such that the tube 102 can bend in the direction of the drain fitting and retain its shape. The corrugated 200 tube 102 comprises enough flexibility to be bent in various directions, and also comprises enough rigidity that the tube 102 can be directed through the drain. Thus, the corrugated 200 tube 102 guides the encapsulated snake machine cable 108 through a one way clean out without getting the cable 108 kinked and/or stuck. If not corrugated, the flexible tube 102 can be segmented to allow for rigidity and flexibility as the tube 102 is directed through the drain.

Additionally, the flexible tube 102 comprises a coupling 202 affixed to at least one end 106. In one embodiment, the flexible tube 102 comprises a coupling 202 affixed to both ends 106. The coupling 202 comprises at least one of a nut 104, a spring coupler, a push coupling, etc., or any other suitable coupling 202 as is known in the art. The coupling 202 allows a connection for an extension component 204. The extension component 204 lengthens the flexible tube 102. Any suitable number of extension components 204 can be utilized as is known in the art, depending on the needs and/or wants of a user. The couplings 202 on the ends 106 of the flexible tube 102 allow the user to join multiple drain cable devices 100 together as needed.

Furthermore, the flexible tube 102 comprises a rubber coating 206 on the outside surface for assisting with grip and durability, as well as for providing easy cleanup. Further, any other suitable coating could be utilized as is known in the art, such as silicone, polymers, etc., depending on the needs and/or wants of a user.

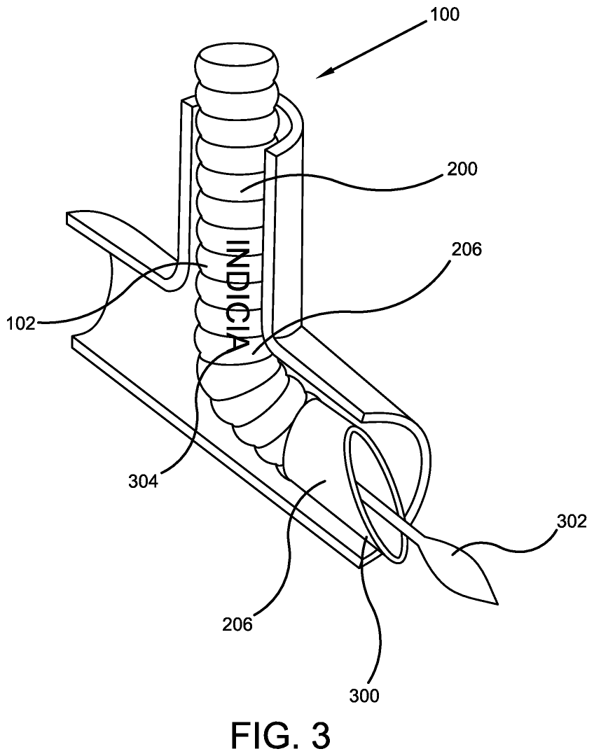

As shown in FIG. 3, an end 106 of a flexible tube 102 is cut at approximately a 45-degree angle 300, or any other suitable angle which helps guide the tube 102 down the drain. Specifically, the angled end 300 helps guide the tube 102 around corners without getting stuck. In one embodiment, the rubber coating 206 is wrapped around the inside edge 302 of the 45-degree angle cutout 300 to protect a user from cuts, scratches, etc., during use.

Accordingly, the plumbing drain cable device 100 is utilized to protect the work area from the actions of a plumber's snake machine cleaning cable 108. Further, operation of a plumber's snake machine cleaning cable 108 is made safer and easier to use with the drain cable device 100. Additionally, the plumbing drain cable device 100 is designed to be used with any size plumber's snake machine cleaning cable 108 as is known in the art.

Furthermore, the plumbing drain cable device 100 comprises a plurality of indicia 304. The flexible tube 102 of the device 100 may include advertising, a trademark, or other letters, designs, or characters, printed, painted, stamped, or integrated into the flexible tube 102, or any other indicia 304 as is known in the art. Specifically, any suitable indicia 304 as is known in the art can be included, such as, but not limited to, patterns, logos, emblems, images, symbols, designs, letters, words, characters, animals, advertisements, brands, etc., that may or may not be plumbing or brand related.

In use, users would bend the flexible tube 102 of the plumbing drain cable device 100 in the direction of a drain fitting, and if more extension components 204 are needed, the nut and adapter component 104 will allow the user to add more extension components 204 to the flexible tube 102, as needed. A snake machine cable 108 will then be threaded into the flexible tube 102, to travel through the flexible tube 102 of the device 100 and up the direction of the drain to the clogged or blocked area. Thus, the flexible tube 102 of the device 100 will have the stiffness and flexibility to be shaped in any way to help guide the snake machine cables 108 through a one way clean out without getting the cables 108 kinked and/or stuck, and by allowing for easy cleanup.

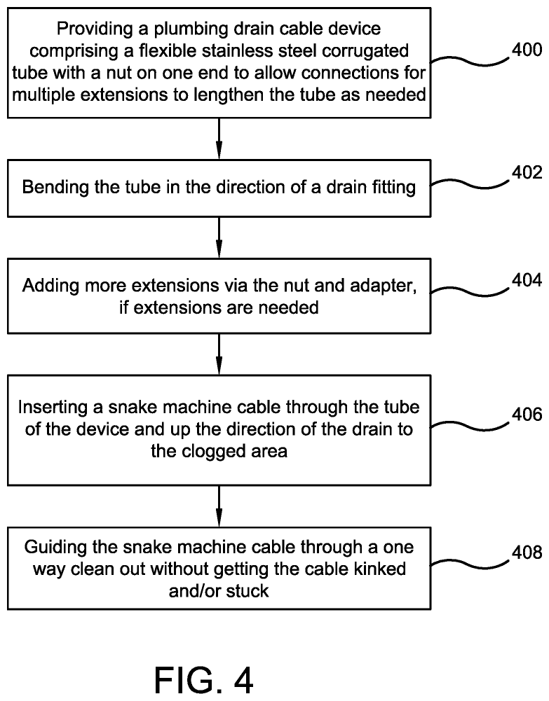

FIG. 4 illustrates a flowchart of the method of clearing a plumbing drain blockage. The method includes the steps of at 400, providing a plumbing drain cable device comprising a flexible stainless steel corrugated tube with a nut on one end to allow connections for multiple extensions to lengthen the tube as needed. The method also comprises at 402, bending the tube in the direction of a drain fitting. Further, the method comprises at 404, adding more extensions via the nut and adapter, if extensions are needed. The method also comprises at 406, inserting a snake machine cable through the tube of the device and up the direction of the drain to the clogged area. Finally, at 408, the method comprises guiding the snake machine cable through a one way clean out without getting the cable kinked and/or stuck.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “plumbing drain cable device”, “drain cable device”, “drain device”, and “device” are interchangeable and refer to the plumbing drain cable device 100 of the present invention.

Notwithstanding the foregoing, the plumbing drain cable device 100 of the present invention can be of any suitable size and configuration as is known in the art without affecting the overall concept of the invention, provided that it accomplishes the above-stated objectives. One of ordinary skill in the art will appreciate that the plumbing drain cable device 100 as shown in FIGS. 1-4 are for illustrative purposes only, and that many other sizes and shapes of the plumbing drain cable device 100 are well within the scope of the present disclosure. Although the dimensions of the plumbing drain cable device 100 are important design parameters for user convenience, the plumbing drain cable device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plumbing drain cable device used for clearing a plumbing drain blockage, the plumbing drain cable device comprising:
a flexible tube; and
a coupling affixed to at least one end of the flexible tube;
wherein a snake machine cable is threaded through the flexible tube during use; and
further wherein the coupling allows an extension component to be connected to the flexible tube to lengthen the flexible tube.

2. The plumbing drain cable device of claim 1, wherein the flexible tube is manufactured of stainless steel.

3. The plumbing drain cable device of claim 2, wherein the flexible tube is corrugated along its length to provide both flexibility and rigidity.

4. The plumbing drain cable device of claim 3, wherein a coupling is affixed to both ends of the flexible tube.

5. The plumbing drain cable device of claim 4, wherein the coupling comprises a nut.

6. The plumbing drain cable device of claim 5, wherein multiple extension components are secured to the flexible tube.

7. The plumbing drain cable device of claim 6, wherein the flexible tube comprises a rubber coating on an outside surface for grip and durability.

8. The plumbing drain cable device of claim 7, wherein an end of the flexible tube is cut at approximately a 45-degree angle to help guide the flexible tube down a drain.

9. The plumbing drain cable device of claim 8, wherein a rubber coating is wrapped around an inside edge of the 45-degree angle cutout to protect against cuts.

10. The plumbing drain cable device of claim 9 further comprising a plurality of indicia.

11. A plumbing drain cable device used for clearing a plumbing drain blockage, the plumbing drain cable device comprising:
a corrugated flexible tube; and
a coupling affixed to at least one end of the corrugated flexible tube;
wherein a snake machine cable is threaded through the corrugated flexible tube during use;
wherein the coupling allows an extension component to be connected to the corrugated flexible tube to lengthen the corrugated flexible tube; and
further wherein an end of the corrugated flexible tube is cut at approximately a 45-degree angle to help guide the corrugated flexible tube down a drain.

12. The plumbing drain cable device of claim 11, wherein the corrugated flexible tube is manufactured of stainless steel.

13. The plumbing drain cable device of claim 11 further comprising a plurality of indicia.

14. The plumbing drain cable device of claim 11, wherein a coupling is affixed to both ends of the corrugated flexible tube.

15. The plumbing drain cable device of claim 12, wherein the coupling comprises a nut.

16. The plumbing drain cable device of claim 13, wherein multiple extension components are secured to the corrugated flexible tube.

17. The plumbing drain cable device of claim 11, wherein the corrugated flexible tube comprises a rubber coating on an outside surface for grip and durability.

18. The plumbing drain cable device of claim 17, wherein a rubber coating is wrapped around an inside edge of the 45-degree angle cutout to protect against cuts.

19. The plumbing drain cable device of claim 11, wherein the corrugated flexible tube can be used with any size snake machine cable.

20. A method of clearing a plumbing drain blockage, the method comprising the steps of:
providing a plumbing drain cable device comprising a flexible stainless steel corrugated tube with a nut on one end to allow connections for multiple extensions to lengthen the tube as needed;
bending the tube in the direction of a drain fitting;
adding more extensions via the nut and adapter, if extensions are needed;
inserting a snake machine cable through the tube of the device and up the direction of the drain to the clogged area; and
guiding the snake machine cable through a one way clean out without getting the cable kinked and/or stuck.
